(19) United States
(12) Patent Application Publication
(10) Pub. No.: US 2015/0198083 A1
(43) Pub. Date: Jul. 16, 2015

(54) DUAL-FUEL ENGINE HAVING EXTENDED VALVE OPENING

(71) Applicant: Electro-Motive Diesel Inc., LaGrange, IL (US)

(72) Inventors: Deep Bandyopadhyay, Naperville, IL (US); Vijaya Kumar, Darien, IL (US)

(73) Assignee: Electro-Motive Diesel Inc., LaGrange, IL (US)

(21) Appl. No.: 14/154,544

(22) Filed: Jan. 14, 2014

(51) Int. Cl. F02B 43/04; F01L 31/08

(52) U.S. Cl. CPC F02B 43/04; F01L 31/08

(57) ABSTRACT

A method of operating a dual-fuel engine having a combustion chamber and at least one valve associated with the combustion chamber is disclosed. The method may include moving the at least one valve from a flow blocking position to a flow passing position during a power stroke of the dual-fuel engine, and injecting gaseous fuel into the combustion chamber. The method may also include selectively holding the at least one valve between the flow blocking position and the flow passing position during at least a portion of a compression stroke of the dual-fuel engine after an end of injection of the gaseous fuel, and releasing the at least one valve and allowing the at least one valve to move to the flow blocking position during the compression stroke. The method may further include injecting liquid fuel into the combustion chamber to ignite the gaseous fuel.

### TECHNICAL FIELD

The present disclosure is directed to a dual-fuel engine and, more particularly, to a dual-fuel engine having an extended valve opening.

### BACKGROUND

Due to the rising cost of liquid fuel (e.g. diesel fuel) and ever increasing restrictions on exhaust emissions, engine manufacturers have developed dual-fuel engines. An exemplary dual-fuel engine provides injections of a low-cost gaseous fuel (e.g. natural gas) through air intake ports of the engine's cylinders. The gaseous fuel is introduced with clean air that enters through the same intake ports and is ignited together with liquid fuel that is injected separately during each combustion cycle. Because a lower-cost fuel is used together with liquid fuel, cost efficiency is improved. In addition, combustion of the gaseous and liquid fuel mixture may result in a reduction of regulated emissions.

Typically, dual-fuel engines require a lower compression pressure to ignite the injected fuel compared to conventional single-fuel engines. That is, a pressure within each cylinder immediately prior to ignition can be lower in dual-fuel applications. If the compression pressure is too high, ignition can occur prematurely, resulting in lower efficiency and higher combustion chamber pressures and temperatures. The higher pressures and temperatures can cause damage to the engine and/or reduce performance of the engine.

One way to lower the compression pressure in the engine's cylinders is to change a geometric compression ratio (e.g., a ratio of a maximum volume in a cylinder to a minimum volume in the cylinder during a piston stroke) of the engine's cylinders. However, this solution can be costly and require significant repair time. Another way to lower the compression pressure in the engine's cylinders is to extend an opening of one or more valves associated the engine's cylinders during a compression stroke of the piston.

An example of a system that extends an opening of an engine's valve is disclosed in U.S. Pat. No. 7,178,491 that issued to Chang on Feb. 20, 2007. In particular, the '491 patent discloses a system having an engine equipped with an engine valve and a valve actuation system. The engine valve moves between a closed position to block a flow of fluid and an open position to allow the flow of fluid during a compression stroke. When a crankshaft is about 170° past a top-dead-center (TDC) position and the engine valve is at least partially open during the compression stroke, hydraulic fluid is provided to a chamber of the valve actuation system to operably engage the engine valve and prevent the engine valve from moving to the closed position. After about 30° further rotation of the crankshaft, the hydraulic fluid is released from the chamber of the valve actuation system, and the engine valve is allowed to move to the closed position. By extending the engine valve opening, pressure within the engine's cylinder may be reduced, resulting in improved engine performance in some applications.

Although the system of the '491 patent may be suitable for some applications, it may still be less than optimal. For example, the engine valve of the '491 patent may be held open for too long. Also, the engine valve of the '491 patent may be held in a position at which a flow area is too large, possibly allowing too much fluid to pass through the engine valve. In dual-fuel applications, if the engine valve is held open for too long or too much fluid is allowed to pass through the engine valve, a significant quantity of gaseous fuel can leak through the engine valve and be exhausted prematurely. In these situations, the leaked gaseous fuel does not contribute to the combustion process, resulting in poor fuel efficiency and costly fueling losses.

The disclosed engine is directed to overcoming one or more of the problems set forth above and/or other problems of the prior art.

### SUMMARY

In one aspect, the present disclosure is directed to a method of operating a dual-fuel engine having a combustion chamber and at least one valve associated with the combustion chamber. The method may include moving the at least one valve from a flow blocking position to a flow passing position during a power stroke of the dual-fuel engine, and injecting gaseous fuel into the combustion chamber. The method may also include selectively holding the at least one valve between the flow blocking position and the flow passing position during at least a portion of a compression stroke of the dual-fuel engine after an end of injection of the gaseous fuel, and releasing the at least one valve and allowing the at least one valve to move to the flow blocking position during the compression stroke. The method may further include injecting liquid fuel into the combustion chamber to ignite the gaseous fuel after the at least one valve is at the flow blocking position during the compression stroke.

In another aspect, the present disclosure is directed to a valve actuation system for a dual-fuel engine. The valve actuation system may include at least one valve moveable between a flow blocking position and a flow passing position. The valve actuation system may also include a valve actuator operably connected to the at least one valve. The valve actuator may be configured to move the at least one valve from the flow blocking position to the flow passing position during a power stroke. The valve actuator may also be configured to move the at least one valve towards the flow blocking position during a compression stroke, and selectively hold the at least one valve between the flow blocking position and the flow passing position during the compression stroke after an end of injection of gaseous fuel. The valve actuator may further be configured to move the at least one valve to the flow blocking position during the compression stroke before a start of injection of liquid fuel.

In yet another aspect, the present disclosure is directed to an engine. The engine may include an engine block at least partially defusing a cylinder, and a crankshaft rotatably disposed within the engine block. The engine may also include a cylinder head associated with the cylinder, a piston located to reciprocate within the cylinder, and a combustion chamber at least partially defined by the cylinder, the cylinder head, and the piston. The engine may further include a gaseous fuel injector configured to inject gaseous fuel into the combustion chamber, and a liquid fuel injector configured to inject liquid fuel into the combustion chamber. The engine may also include at least one valve moveable between a flow blocking position and a flow passing position, and a valve actuator operably connected to the at least one valve. The valve actuator may be configured to move the at least one valve from the flow blocking position to the flow passing position during a power stroke of the piston. The valve actuator may also be configured to move the at least one valve towards the flow blocking position during a compression stroke of the piston, and selectively hold the at least one valve between the flow blocking position and the flow passing position during the compression stroke after an end of injection of gaseous fuel. The valve actuator may further be configured to move the at least one valve to the flow blocking position during the compression stroke before a start of injection of liquid fuel.

### BRIEF DESCRIPTION OF THE DRAWINGS

FIG. 1 is a cross-sectional illustration of an engine equipped with an exemplary disclosed valve actuation system;

FIG. 2 is a graphic illustration of an exemplary operation performed by the valve actuation system of FIG. 1; and

FIG. 3 is a graphic illustration of another exemplary operation performed by the valve actuation system of FIG. 1.

### DETAILED DESCRIPTION

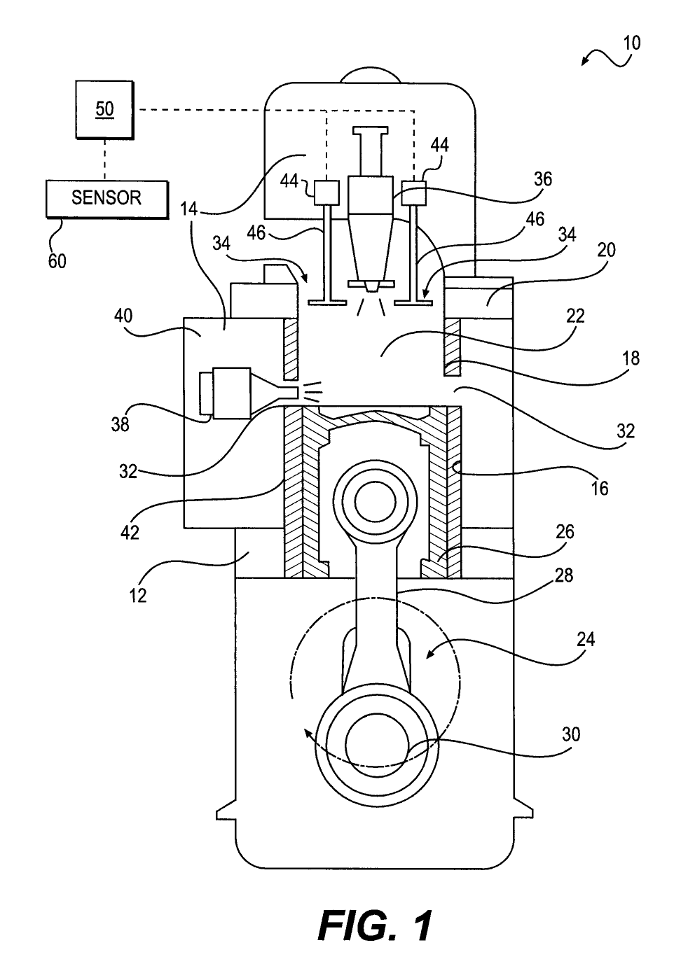

FIG. 1 illustrates an exemplary internal combustion engine 10. Engine 10 is depicted and described as a two-stroke, dual-fuel engine. Engine 10 may include an engine block 12 that at least partially defines a plurality of cylinders 16 (only one shown), each having an associated cylinder head 20. A cylinder liner 18 may be disposed within each engine cylinder 16, and cylinder head 20 may close off an end of liner 18. A piston 26 may be slidably disposed within each cylinder liner 18. Each cylinder liner 18, cylinder head 20, and piston 26 may together define a combustion chamber 22 that receives fuel from a fuel system 14 mounted to engine 10. It is contemplated that engine 10 may include any number of engine cylinders 16 with corresponding combustion chambers 22.

Within engine cylinder liner 18, piston 26 may be configured to reciprocate between a bottom-dead-center (BDC) or lower-most position, and a top-dead-center (TDC) or upper-most position. In particular, a power assembly 24 may be an assembly that includes piston 26 pivotally connected to a rod 28, which may in turn be pivotally connected to a crankshaft 30. Crankshaft 30 of engine 10 may be rotatably disposed within engine block 12 and each piston 26 coupled to crankshaft 30 by rod 28, so that a sliding motion of each piston 26 within liner 18 results in a rotation of crankshaft 30. Similarly, a rotation of crankshaft 30 may result in a sliding motion of piston 26. As crankshaft 30 rotates through about 180 degrees, piston 26 and connecting rod 28 may move through one full stroke between BDC and TDC. Engine 10, being a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn into combustion chamber 22 via one or more gas exchange ports (e.g., air intake ports) 32 located within a sidewall of cylinder liner 18. In particular, as piston 26 moves downward within liner 18, a position will eventually be reached at which air intake ports 32 are no longer blocked by piston 26 and instead are fluidly communicated with combustion chamber 22. When air intake ports 32 are in fluid communication with combustion chamber 22 and a pressure of air at air intake ports 32 is greater than a pressure within combustion chamber 22, air will pass through air intake ports 32 into combustion chamber 22. In some embodiments, gaseous fuel (e.g., methane or natural gas) may be introduced into combustion chamber 22 (e.g., radially injected) via a gaseous fuel injector 38. Gaseous fuel injector 38 may be configured to inject gaseous fuel radially into combustion chamber 22 through a corresponding air intake port 32 after the air intake port 32 is opened by movement of piston 26.

The gaseous fuel from gaseous fuel injector 38 may mix with the air to form a fuel/air mixture within combustion chamber 22. Eventually, piston 26 will start an upward movement that blocks air intake ports 32 and compresses the air/fuel mixture. As the air/fuel mixture within combustion chamber 22 is compressed, a temperature of the mixture may increase. At a point when piston 26 is near TDC, a liquid fuel (e.g. diesel or other petroleum-based liquid fuel) may be injected into combustion chamber 22 via a liquid fuel injector 36.

Liquid fuel injector 36 may be positioned inside cylinder head 20 and configured to inject liquid fuel into a top of combustion chamber 22 by releasing fuel axially towards an interior of cylinder liner 18 in a generally cone-shaped pattern. Liquid fuel injector 36 may be configured to cyclically inject a fixed amount of liquid fuel, for example, depending on a current engine speed and/or load. In one embodiment, engine 10 may be arranged to run on liquid fuel injections alone, a smaller amount of liquid fuel mixed with the gaseous fuel, or gaseous fuel injections alone.

The liquid fuel injected by liquid fuel injector 36 into combustion chamber 22 may be ignited by the hot air/fuel mixture already within combustion chamber 22, causing combustion of both types of fuel and resulting in a release of chemical energy in the form of temperature and pressure spikes within combustion chamber 22. During a first phase of the power/exhaust/intake stroke, the pressure spike within combustion chamber 22 may force piston 26 downward, thereby imparting mechanical power to crankshaft 30. At a particular point during this downward travel, one or more gas exchange ports (e.g., exhaust ports) 34 located within cylinder head 20 may open to allow pressurized exhaust within combustion chamber 22 to exit and the cycle will restart.

An exhaust valve 46 may be disposed within each exhaust port 34 and configured to open and close a respective exhaust port 34. In the disclosed embodiment, there are two exhaust valves 46 associated with each cylinder 16 in a cyclical manner. Exhaust valves 46 may be movable between a first position, at which exhaust valve 46 blocks a flow of fluid through their respective exhaust ports 34 (e.g., closed position), and a second position, at which exhaust valve 46 allows the flow of fluid to pass through their respective exhaust ports 34 (e.g., open position).

As also shown in FIG. 1, valve actuators 44 may be operatively associated with engine 10 to move or “lift” the associated exhaust valves 46 between the open and closed positions at desired timings relative to the rotation of crankshaft 26 and/or the position of piston 26. In some embodiments, engine 10 may include one valve actuator 44 for each exhaust valve 46. In other embodiments, engine 10 may include one valve actuator 44 for each cylinder head 20 that is configured to actuate all of the exhaust valves 46 of that cylinder head 20. It is also contemplated that a single valve actuator could actuate the exhaust valves 46 associated with multiple cylinder heads 20, if desired. Valve actuators 44 may each embody, for example, a cam/push-rod/rocker arm arrangement, a solenoid actuator, a hydraulic actuator, and/or any other means for actuating known in the art. It should be noted that the timing at which exhaust valves 46 are opened and/or closed may have an effect on engine operation (e.g., an effect on cylinder pressure, temperature, efficiency, ignition timing, etc.), and may be variably controlled in some embodiments.

A controller 50 may be in communication with engine 10 and valve actuators 44, and configured to selectively regulate movement of exhaust valves 46. Controller 50 may embody a single or multiple microprocessors, field programmable gate arrays (FPGAs), digital signal processors (DSPs), etc., that is configured to control one or more aspects of the operation of engine 10. For example, controller 50 may be programmed to control valve actuators 44. Controller 50 may control valve actuator 44 by transmitting a signal, such as, for example, a current, to control valve actuators 44. The transmitted signal may result in the opening, closing, and/or blocking of exhaust valve 46. In some embodiments, controller 50 may control valve actuators 44 based on the current operating conditions of engine 10 (e.g., a type of fuel being used) and/or information received from one or more sensors 60 strategically located throughout engine 10. Numerous commercially available microprocessors can be configured to perform the functions of these components. Various known circuits may be associated with these components, including power supply circuitry, signal-conditioning circuitry, actuator driver circuitry (i.e., circuitry powering solenoids, motors, or piezo actuators), and communication circuitry.

Sensor 60 may be configured to monitor a particular operating parameter of engine 10 and generate a corresponding signal directed to controller 50. For example, sensor 60 may embody an intake air pressure sensor, an ambient air pressure sensor, or an in-cylinder pressure sensor. Sensor 60 may be disposed inside of engine 10, such as, for example, directly within cylinder 16 or in an exhaust passageway associated with cylinder 16. The signals generated by sensor 60 may be sent to controller 50 for further processing. As described in greater detail below, controller 50 may use the sensed pressure information, in some embodiments, to control operation of valve actuator 44. Together, valve actuator 44, controller 50, and sensor 60 may form a valve actuation system.

In some embodiments, controller 50 may be configured to receive the signal indicative of an in-cylinder pressure from sensor 60 and then selectively cause valve actuators 44 to extend an opening of exhaust valves 46 based on the signal. For example, if controller 50 determines that the pressure within cylinder 16 during the compression stroke is higher than a threshold pressure level (e.g., a pressure required to ignite the liquid fuel), then controller 50 may cause valve actuators 44 to extend the opening of exhaust valves 46. It is contemplated that, in some embodiments, all cylinders 16 of engine 10 may operate in a similar manner. However, in other embodiments, less than all of cylinders 16 may extend the opening of their associated exhaust valves 46, if desired. By extending the opening of exhaust valves 46 and varying operation of the valve actuation system, performance of engine 10 may be improved.

In other embodiments, controller 50 may be configured to selectively cause valve actuators 44 to extend an opening of exhaust valves 46 based on a type of fuel being used in engine 10. For example, in one application, if both liquid fuel and gaseous fuel are being injected, controller 50 may cause valve actuators 44 to extend the opening of exhaust valves 46. In another application, where only liquid fuel is being injected, controller 50 may not cause valve actuators 44 to extend the opening of exhaust valves 46. In yet another application, if only gaseous fuel is being injected, controller 50 may cause valve actuators 44 to extend the opening of exhaust valves 46. Varying actuation of exhaust valves 46 based on the type(s) of fuel being used may help to provide a desired compression pressure within cylinder 16, thereby preventing early ignition.

It should be noted that, in some embodiments, controller 50 and/or sensor 60 may be omitted. In these embodiments, valve actuators 44 may embody, for example, a cam/push-rod/rocker arm arrangement, and a shape and/or orientation of the cam may control a timing of actuation of exhaust valves 46. For example, in one embodiment, a shape of the cam may be designed to hold exhaust valves 46 at a position between the open and closed positions during the compression stroke, for a specific duration.

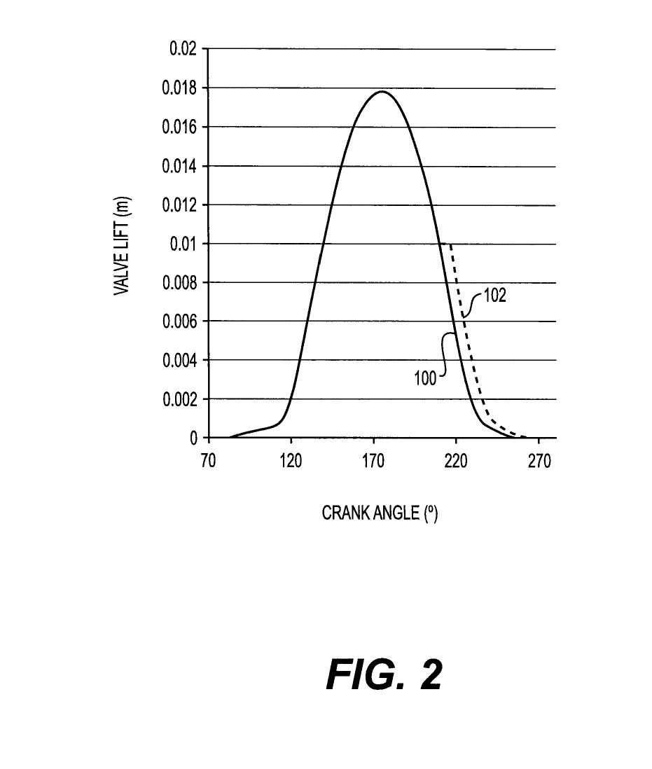

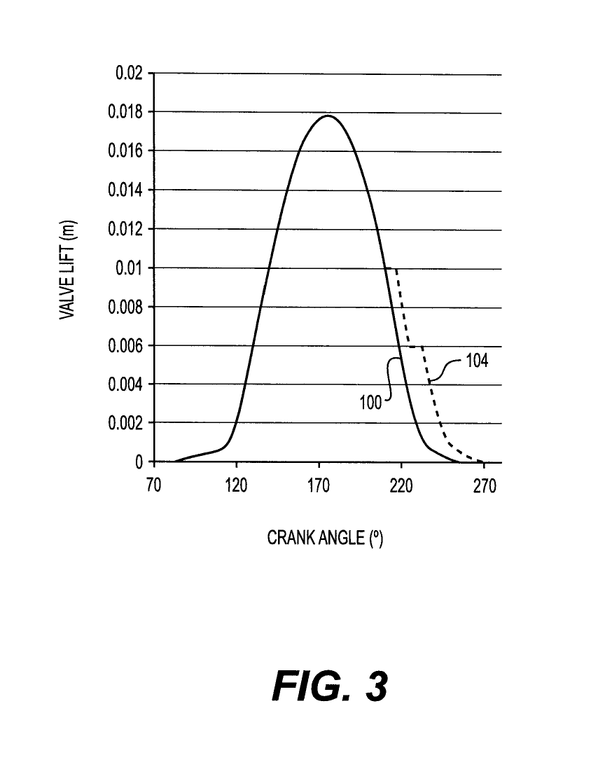

FIGS. 2 and 3 illustrate performance of the valve actuation system during two different operations. These operations will be described in more detail below.

### INDUSTRIAL APPLICABILITY

The disclosed valve actuation system may be implemented into any engine application. The disclosed valve actuation system may lower a compression pressure associated with cylinder 16 by extending an opening of exhaust valves 46, prior to ignition of injected liquid fuel. By lowering the compression pressure associated with cylinder 16, early ignition of gaseous fuel inside cylinder 16 may be prevented, which can lead to improved engine performance and efficiency. Operations of the valve actuation system will now be described with reference to FIGS. 2 and 3.

As illustrated in FIG. 2, a first operation of valve actuation system may extend the opening of exhaust valve 46 from a conventional opening 100 to a first extended opening 102, during the compression stroke. The period or duration of the extended exhaust valve actuation may be measured in terms of the angle of rotation of crankshaft 30 as a function of time or in any other manner readily apparent to one skilled in the art.

During the first operation, piston 26 may move from TDC to BDC, during the power stroke, and exhaust valves 46 may move towards the open position to allow exhaust to exit the combustion chamber 22. Subsequently, piston 26 may move from BDC to TDC, during the compression stroke, and exhaust valves 46 may move towards the closed position to build up pressure within combustion chamber 22 for ignition of liquid fuel. During the closing of exhaust valves 46, gaseous fuel may be injected.

After the gaseous fuel is injected, exhaust valves 46 may be held at a position that is approximately midway between the open and closed positions (i.e., a half-closed position). Exhaust valves 46 may be held at the half-closed position at a time of between about 0° and 10° rotation of crankshaft 30 after an end of injection of gaseous fuel. In one embodiment, exhaust valves 46 may be held at the half-closed position at a time of about 5° rotation of crankshaft 30 after the end of injection of gaseous fuel. The timing of the hold may also be between about 145° and 155° rotation of crankshaft 30 before a start of injection of liquid fuel. In one embodiment, the timing of the hold may be about 150° rotation of crankshaft 30 before the start of injection of liquid fuel. After being held at the half-closed position, exhaust valves 46 may then completely close at a time of between about 95° and 105° rotation of crankshaft 30 before the start of injection of liquid fuel.

Holding exhaust valves 46 at the half-closed position at a time of between about 0° and 10° rotation of crankshaft 30 after the injection of gaseous fuel may sufficiently limit a pressure buildup within cylinder 16 after the injection of gaseous fuel to prevent early ignition. In addition, holding exhaust valves 46 at the half-closed position at a time of between about 145° and 155° rotation of crankshaft 30 before the injection of liquid fuel may allow enough time before the injection of liquid fuel for pressure within cylinder 16 to increase to a desired pressure to ignite the injected liquid fuel.

Referring to FIG. 2, exhaust valves 46 may be held at the half-closed position for a duration of between about 2° and 10° rotation of crankshaft 30. In one embodiment, exhaust valves 46 may be held at the half-closed position for about 5° rotation of crankshaft 30. Also, the valve actuation system may begin holding exhaust valves 46 at the half-closed position when a crank angle of crankshaft 30 is about 210° past TDC.

Holding exhaust valves 46 at a position other than the half-closed position could allow too little or too much pressure out of cylinder 16. For example, holding exhaust valves 46 open at a position closer to the open position may allow too much air and/or gaseous fuel to flow through exhaust ports 34 and be wasted to the exhaust. The wasted air and/or gaseous fuel can be very costly and inefficient. Also, holding exhaust valves 46 open at a position closer to the closed position may not sufficiently limit the pressure buildup within cylinder 16 to prevent early ignition. Additionally, holding exhaust valves 46 open for a duration outside a range of between about 2° and 10° rotation of crankshaft 30 could also allow too little or too much pressure out of cylinder 16. For example, holding exhaust valves 46 at the half-closed position for a duration less than 2° rotation of crankshaft 30 may not sufficiently limit the pressure buildup. Holding exhaust valves 46 at the half-closed position for a duration greater than 10° rotation of crankshaft 30 may allow too much air and/or gaseous fuel to slip to the exhaust. Thus, by holding exhaust valves 46 open at the half-closed position for a duration of about 2° and 10° rotation of crankshaft 30, a compression pressure within cylinder 16 may reach a desired level, while not allowing too much gaseous fuel or air leak through exhaust ports prematurely.

As illustrated in FIG. 3, a second operation of valve actuation system may extend the opening of exhaust valves 46 from the conventional opening 100 to a second extended opening 104. During the second operation, after holding exhaust valves 46 at the half-closed position, exhaust valves 46 may be held at an additional position that is approximately midway between the half-closed and fully closed positions (i.e., at a ¾ closed position). Exhaust valves 46 may be held at the ¾-closed position at a time of between about 20° and 30° rotation of crankshaft 30 after the end of injection of gaseous fuel. In one embodiment, exhaust valves 46 may be held at the ¾-closed position at a time of about 25° rotation of crankshaft 30 after the end of injection of gaseous fuel. The timing of the hold may also be between about 125° and 135° rotation of crankshaft 30 before the start of injection of liquid fuel. In one embodiment, the timing of the hold may be about 130° rotation of crankshaft 30 before the start of injection of liquid fuel. After being held at the ¾-closed position, exhaust valves 46 may then completely close at a time of between about 95° and 105° rotation of crankshaft 30 before the start of injection of liquid fuel.

Referring to FIG. 3, exhaust valves 46 may be held at the ¾-closed position for a duration of between about 2° and 10° rotation of crankshaft 30. In one embodiment, exhaust valves 46 may be held at the ¾ closed position for about 5° rotation of crankshaft 30. In addition, the valve actuation system may begin holding exhaust valves 46 at the ¾ closed position when a crank angle of crankshaft 30 is about 230° past TDC.

By holding exhaust valves 46 open at an additional valve position, this may allow further limiting of the pressure buildup within cylinder 16, during the compression stroke, without significantly increasing an amount of gaseous fuel leaked to the exhaust. In particular, a flow rate through exhaust port 34 may remain substantially the same between the first extended opening 102 and the second extended opening 104. For example, as piston 26 moves upward during the compression stroke, a pressure may increase. As the pressure increases, exhaust valves 46 may be moving closer to the closed position, which decreases a flow area through exhaust port 34. Thus, because the pressure increases as the flow area decreases, the flow rate through exhaust port 34 may remain substantially the same, thus increasing efficiency and performance of engine 10.

The disclosed valve actuation system may sufficiently limit the pressure buildup within cylinder 16 of engine 10. In particular, holding exhaust valves 46 at a location approximately midway between its open and closed positions may provide a desired flow area, allowing sufficient limiting of the pressure buildup without wasting too much gaseous fuel and/or air to exhaust. Also, holding exhaust valves 46 open at a time of between about 0° and 10° rotation of crankshaft 30 after an end of injection of gaseous fuel may sufficiently limit the pressure buildup to prevent early ignition of the gaseous fuel, while still allowing enough pressure and temperature buildup to ignite subsequently injected liquid fuel. Further, holding exhaust valves 46 open for a duration of between about 2° and 10° rotation of crankshaft 30 may allow sufficient time to limit the pressure buildup to a desired level. Additionally, in some embodiments, the disclosed valve actuation system may initiate multiple valve holds, thus further limiting the pressure buildup without sacrificing too much gaseous fuel and/or air.

It will be apparent to those skilled in the art that various modifications and variations can be made to the disclosed engine. Other embodiments will be apparent to those skilled in the art from consideration of the specification and practice of the disclosed engine. It is intended that the specification and examples be considered as exemplary only, with a true scope being indicated by the following claims and their equivalents.

What is claimed is:

1. A method of operating a dual-fuel engine having a combustion chamber and at least one valve associated with the combustion chamber, the method comprising:
moving the at least one valve from a flow blocking position to a flow passing position during a power stroke of the engine;
injecting gaseous fuel into the combustion chamber;
selectively holding the at least one valve between the flow blocking position and the flow passing position during at least a portion of a compression stroke of the engine after an end of injection of the gaseous fuel;
releasing the at least one valve and allowing the at least one valve to move to the flow blocking position during the compression stroke; and
injecting liquid fuel into the combustion chamber to ignite the gaseous fuel after the at least one valve is at the flow blocking position during the compression stroke.

2. The method of claim 1, wherein selectively holding the at least one valve includes holding the at least one valve at a position approximately midway between the flow blocking position and the flow passing position.

3. The method of claim 1, further including sensing a pressure within the combustion chamber, wherein selectively holding the at least one valve includes holding the at least one valve only when the sensed pressure is above a pressure required to ignite the liquid fuel.

4. The method of claim 1, wherein selectively holding the at least one valve includes holding the at least one valve only when both gaseous fuel and liquid fuel are being simultaneously consumed by the engine.

5. The method of claim 1, wherein selectively holding the at least one valve includes inhibiting holding the at least one valve when only liquid fuel is being consumed by the engine.

6. The method of claim 1, wherein the engine includes a crankshaft, and selectively holding the at least one valve includes holding the at least one valve for a duration of between about 2° and 10° rotation of the crankshaft.

7. The method of claim 6, wherein selectively holding the at least one valve includes beginning to hold the at least one valve at a time of between about 0° and 10° rotation of the crankshaft after the end of injection of gaseous fuel.

8. The method of claim 6, wherein selectively holding the at least one valve includes beginning to hold the at least one valve at a time of between about 145° and 155° rotation of the crankshaft before a start of injection of liquid fuel.

9. The method of claim 6, wherein selectively holding the at least one valve includes beginning to hold the at least one valve when a crank angle of the crankshaft is about 210° after a top-dead-center position.

10. The method of claim 1, wherein selectively holding the at least one valve includes holding the at least one valve at a first position, and the method further includes selectively holding the at least one valve at a second position between the flow blocking position and the flow passing position.

11. The method of claim 10, wherein the engine includes a crankshaft, and selectively holding the at least one valve at the second position includes holding the at least one valve for a duration of between about 2° and 10° rotation of the crankshaft.

12. A valve actuation system for a dual-fuel engine, comprising:
at least one valve moveable between a flow blocking position and a flow passing position; and
a valve actuator operably connected to the at least one valve and configured to:
move the at least one valve from the flow blocking position to the flow passing position during a power stroke;
move the at least one valve towards the flow blocking position during a compression stroke;
selectively hold the at least one valve between the flow blocking position and the flow passing position during the compression stroke after an end of injection of gaseous fuel; and
move the at least one valve to the flow blocking position during the compression stroke before a start of injection of liquid fuel.

13. The system of claim 12, wherein the valve actuator is configured to hold the at least one valve at a position approximately midway between the flow blocking position and the flow passing position.

14. The system of claim 12, wherein the valve actuator is configured to hold the at least one valve at two different positions between the flow blocking position and the flow passing position.

15. The system of claim 12, wherein the system further includes:
a sensor configured to generate a signal indicative of a pressure associated with the engine; and
a controller in communication with the sensor and configured to selectively cause the valve actuator to hold the at least one valve when the pressure is above a pressure required to ignite the liquid fuel.

16. The system of claim 12, wherein the engine includes a crankshaft, and the valve actuator is configured to hold the at least one valve for a duration of between about 2° and 10° rotation of the crankshaft.

17. The system of claim 16, wherein the valve actuator is configured to begin holding the at least one valve at a time of between about 0° and 10° rotation of the crankshaft after the end of injection of gaseous fuel.

18. The system of claim 16, wherein the valve actuator is configured to begin holding the at least one valve at a time of between about 145° and 155° rotation of the crankshaft before the start of injection of liquid fuel.

19. The system of claim 16, wherein the valve actuator is configured to begin holding the at least one valve when a crank angle of the crankshaft is about 210° after a top-dead-center position.

20. An engine, comprising:
an engine block at least partially defining a cylinder;
a crankshaft rotatably disposed within the engine block;
a cylinder head associated with the cylinder;
a piston located to reciprocate within the cylinder;
a combustion chamber at least partially defined by the cylinder, the cylinder head, and the piston;
a gaseous fuel injector configured to inject gaseous fuel into the combustion chamber;
a liquid fuel injector configured to inject liquid fuel into the combustion chamber;
at least one valve moveable between a flow blocking position and a flow passing position; and
a valve actuator operably connected to the at least one valve and configured to:
move the at least one valve from the flow blocking position to the flow passing position during a power stroke of the piston;
move the at least one valve towards the flow blocking position during a compression stroke of the piston;
selectively hold the at least one valve between the flow blocking position and the flow passing position during the compression stroke after an end of injection of gaseous fuel; and
move the at least one valve to the flow blocking position during the compression stroke before a start of injection of liquid fuel.
